(19) United States
(12) Patent Application Publication
(10) Pub. No.: US 2011/0181576 A1
(43) Pub. Date: Jul. 28, 2011

(54) ELECTRONIC PAPER DEVICE

(75) Inventors: CHUN-WEI PAN, Tu-Cheng (TW); ZAI-AN PAN, Shenzhen City (CN); ZHENG-WEI MAO, Shenzhen City (CN); CHIU-HSIUNG LIN, Tu-Cheng (TW); KUAN-HONG HSIEH, Tu-Cheng (TW)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/915,029

(22) Filed: Oct. 29, 2010

(30) Foreign Application Priority Data
Jan. 28, 2010 (CN) 201010300899.0

(51) Int. Cl. G09G 5/00; G02F 1/167

(52) U.S. Cl. 345/211; 359/296

(57) ABSTRACT

An electronic paper device is provided. The electronic paper device includes a conductive layer, a number of pixel electrodes, an electrophoretic ink layer, a common electrode layer, a voltage detection unit, and a processing unit. Each pixel electrode corresponds to a coordinate of a coordinate system. The electrophoretic ink layer is electrically connected between the number of pixel electrodes and the common electrode layer. The conductive layer and the common electrode layer have a different voltage when the electronic paper device is powered on. When the user touches the electronic paper device and causes the conductive layers to contact a pixel electrode corresponding to the touch position, the pixel electrode obtains the voltage of the conductive layer and an electric field is form between the pixel electrode and the common electrode layer. This causes the color to change at the position that is corresponding to the touched position.

### BACKGROUND

1. Related Applications

The subject matter disclosed in this application is related to subject matters disclosed in copending applications entitled, “ELECTRONIC PAPER DEVICE”, filed **** (Atty. Docket No. US32105); “ELECTRONIC PAPER DEVICE”, filed **** (Atty. Docket No. US32106); “ELECTRONIC PAPER DEVICE”, filed **** (Atty. Docket No. US32107), and assigned to the same assignee as named herein.

2. Technical Field

The present disclosure relates to electronic paper devices and, particularly, to an electrophoretic style, electronic paper device.

3. Description of Related Art

Electrophoretic electronic paper (e-paper) devices have been the subject of intense research and development for a number of years. Electrophoretic e-paper devices have attributes of good brightness and contrast, wide viewing angles, state bistability (the term “bistability” is used herein in its conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times), and low power consumption when compared with liquid crystal displays.

The functions of the electrophoretic e-paper devices are increasing as well, for example, the electrophoretic e-paper devices that can execute drawing function are being produced. In an electrophoretic drawing device, electrophoretic particles in a display media of the device migrate toward or away from the drawing surface of the device upon application of an electric field across the display media. For example, the drawing device can contain a back electrode covered by an electrophoretic coating. For writing, a positive voltage is applied to the back electrode and a stylus contacting the electrophoretic coating is set at ground. The stylus acts as a top electrode in a local area. A voltage potential is created between the stylus and the back electrode, which causes migration of the electrophoretic particles and a color change of the device. Electrophoretic display devices with touch input function are also produced.

However, the existing electrophoretic e-paper devices must need a particular stylus to achieve the drawing function, and usually do not come with drawing functions and touch input function together.

Therefore, it is desirable to provide an electrophoretic display device to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, cross-sectional view of an electronic paper device in accordance with an exemplary embodiment.

FIG. 2 is a schematic view of a substructure of the electronic paper device 1 capable of executing an eraser function of FIG. 1 in accordance with an exemplary embodiment.

FIG. 3 is a schematic view of a substructure of the electronic paper device capable of executing an eraser function of FIG. 1 in accordance with another embodiment.

### DETAILED DESCRIPTION

Embodiments of the present disclosure will now be described in detail below, with reference to the accompanying drawings.

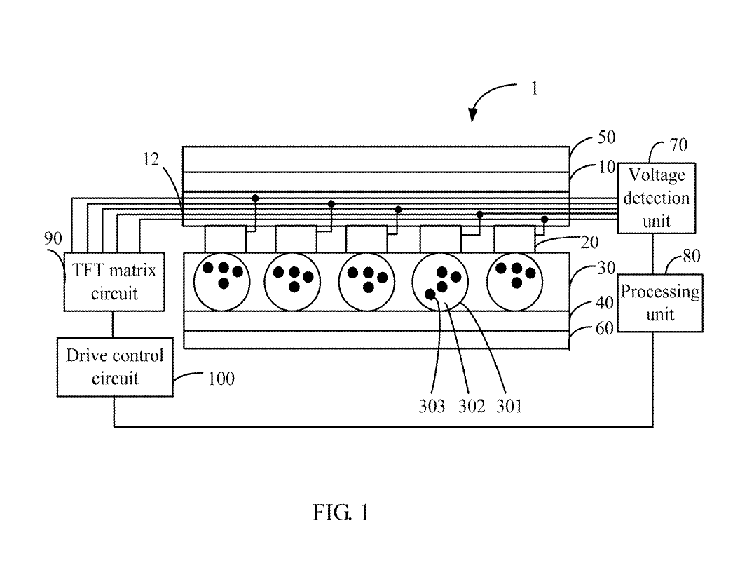

Referring to FIG. 1, an electronic paper (e-paper) device 1 with drawing function and touch input function is provided. In the embodiment, the e-paper device 1 is an electrophoretic style e-paper device. The e-paper device 1 includes a conductive layer 10, a number of pixel electrodes 20, an electrophoretic ink layer 30, and a common electrode layer 40. The conductive layer 10 corresponds to a display surface of the e-paper device 1, in the embodiment, the conductive layer 10 and the pixel electrodes 20 are transparent and can be made of indium tin oxide. The pixel electrodes 20 are disposed between the conductive layer 10 and the electrophoretic ink layer 30, are arranged in a matrix pattern, the pixel electrodes 20 are separated from each other. The electrophoretic ink layer 30 is electrically connected between the pixel electrodes 20 and the common electrode layer 40.

In the embodiment, the e-paper device 1 further includes a spacer layer 12, which is disposed between the conductive layer 10 and the pixel electrodes 20. The spacer layer 12 spaces the conductive layer 10 and the pixel electrodes 20 apart when the e-paper device 1 is not depressed.

The electrophoretic ink layer 30 includes a number of cavities 301 arranged in a matrix pattern. Each cavity 301 is between one pixel electrode 20 and the common electrode layer 40. In the embodiment, the cavities 302 are microcapsules and can be in the form of spherical, elliptical, or tubular. In other embodiments, the cavities 302 may be micro-cups.

Each cavity 301 contains suspension fluid 302 and at least one type of charged particles 303. In the embodiment, the charged particles 303 are black, when the charged particles 303 in a cavity 301 are driven to move towards the pixel electrode 20, the cavity 301 displays black viewed from the display surface of the e-paper device 1. When the charged particles 303 in the cavity 301 are driven to move away from the pixel electrode 20, the cavity 301 displays another color, such as white. In the embodiment, the common electrode layer 40 and the conductive layer 10 has different voltage, for example, the common electrode layer 40 and the conductive layer 10 are respectively connected to a cathode and an anode of a power source (not shown) and has a negative voltage and a positive voltage. In the embodiment, when the e-paper device 1 is powered off, the common electrode layer 40 and the conductive layer 10 do not have voltage, for example, the power source stops to provide power to the common electrode layer 40 and the conductive layer 10 when the e-paper device 1 is powered off. In other embodiments, when the e-paper device 1 is powered off, the common electrode layer 40 and the conductive layer 10 both have voltage. When the e-paper device 1 is depressed or is touched, the pixel electrode 20 corresponding to the touch position contacts with the conductive layer 10, then the pixel electrode 20 obtains the voltage of the conductive layer 10, and generates an electric field between the pixel electrode 20 and the common electrode layer 40. Then the charged particles 303 are driven to move, causing a color change of the touch position of the e-paper device 1.

The e-paper device 1 further includes an upper substrate 50 and a lower substrate 60. The upper substrate 50 covers the conductive layer 10 and is used to protect the e-paper device 1, in the embodiment the upper substrate 50 is transparent. The lower substrate 60 holds the conductive layer 10, the pixel electrodes 20, the electrophoretic ink layer 30, the common electrode layer 40, and the upper substrate 50.

The e-paper device 1 further includes a voltage detection unit 70 and a processing unit 80. The voltage detection unit 70 is electrically connected to the pixel electrodes 20, and detects the voltage of the pixel electrodes 20. In the embodiment, each pixel electrode 20 corresponds to a coordinate of a coordinate system, such as a Descartes coordinate system. When the conductive layer 10 is depressed to contact a pixel electrode 20, the pixel electrode 20 obtains the voltage from the conductive layer 10, the voltage detection unit 70 detects the voltage of the pixel electrode 20 and produces a touch signal. The processing unit 80 is connected to the voltage detection unit 70, and receives the touch signal from the voltage detection unit 70 and determines a touch position corresponding to the pixel electrode 20 having the voltage according to the touch signal. The processing unit 80 further determines an icon displayed on the touch position of the e-paper device 1, and executes the function corresponding to the determined icon. Accordingly, the e-paper device 1 achieves the touch input function. In the embodiment, the phrase “icon” typically is a graphic user interface (GUI) element that can be displayed and is capable of triggering a function in response to a touch operation.

In the embodiment, the e-paper device 1 further can achieve a display function, namely, the e-paper device 1 can be used as a common display device such as a liquid crystal display. The e-paper device 1 further includes a thin-film transistor (TFT) matrix circuit 90 and a drive control circuit 100. The TFT matrix circuit 90 includes a number of TFTs (not shown), and each of the TFTs is electrically connected to one pixel electrode 20. The drive control circuit 100 is electrically connected between the TFT matrix circuit 90 and the processing unit 80. The processing unit 80 further produces a display signal when the display content of the e-paper device 1 is updated according to a user operation, for example, opening an image file. The drive control circuit 100 receives the display signal, turns on the corresponding TFTs and applies the corresponding driving voltage to the pixel electrodes 20 connected to the TFTs, which are turned on. Then the charged particles 303 of the cavities 301 connected to the pixel electrodes 20, which are applied voltage are driven to move toward to the pixel electrodes 20 or move away from the pixel electrodes 20. Then the e-paper device 1 displays the image corresponding to the display signal.

When the drive control circuit 100 applies the driving voltage to the pixel electrode 20, the voltage detection unit 70 detects the voltage of the pixel electrode 20, and the processing unit 80 determines the positions corresponding to the pixel applied voltage are touched, however, no touch happens on the e-paper device 1 at this time. Therefore, in order to avoid the processing unit 80 mistakenly determining that there is a touch on the e-paper device 1, the processing unit disables the voltage detection unit 70 when outputting the display signal to the drive control circuit 100.

In the embodiment, the e-paper device 1 further has a clear mode in which drawing displayed on the e-paper device 1 can be cleared entirely. When the e-paper device 1 enters the clear mode, the processing unit 80 transmits a clearing signal to the drive control circuit 100, the drive control circuit 100 turns on all of the TFTs and applies corresponding driving voltage to all of the pixel electrodes 20 to cause all of the cavities 301 to display white.

In the embodiment, the e-paper device 1 further has an erase mode in which the drawing displayed on the e-paper device 1 can be erased selectively. When the e-paper device 1 is in the erase mode and is touched in the erase mode, as described above, the processing unit 80 determines the coordinates of the touch position. The processing unit 80 controls the drive control circuit 100 to apply a corresponding voltage to the pixel electrode 20 located on the touch position to cause the cavity 301 connected to the pixel electrode 20 to display white, that is, the drawing on the touch position is erased. In the embodiment, the e-paper device 1 provides a menu including a menu item for entering the clearing mode and a menu item for entering the erase mode. In another embodiment, the electronic device 1 provides two predetermined buttons for respectively entering the clearing mode and the erase mode.

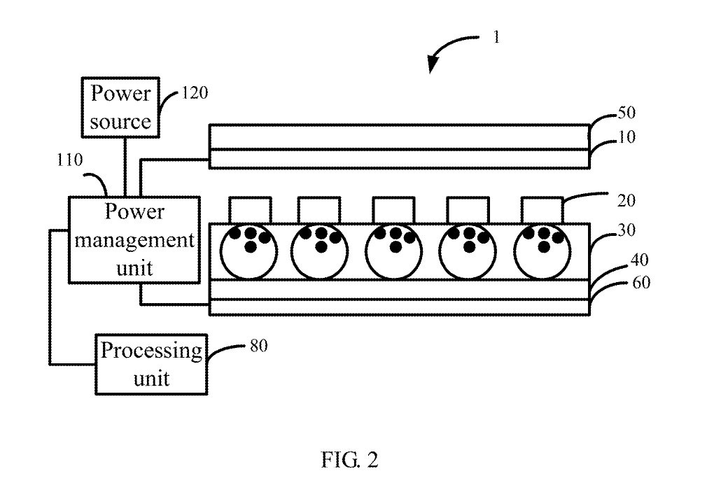

FIG. 2 is a schematic view of a substructure of the electronic paper device 1 capable of executing an eraser function in accordance with an embodiment. In the embodiment, the e-paper device 1 further includes a power management unit 110 and a power source 120. The power management unit 110 is connected to the conductive layer 10 and the common electrode layer 40. The processing unit 80 controls the power management unit 110 to provide different voltage to the conductive layer 10 and the common electrode layer 40. When the voltage provided to the conductive layer 10 and the common electrode layer 40 are exchanged, the e-paper device 1 enters or exists the erase mode correspondingly.

For example, in the embodiment, supposes the charged particles 303 are black color and positive charged. When the power management unit 110 provides a negative voltage to the conductive layer 10 and provides a positive voltage to the common electrode layer 40, as described above, once the e-paper device 1 is touched, the pixel electrode 20 corresponding to the touch position contacts the conductive layer 10, and are at negative voltage. Then the charged particles 303 are driven to move toward to the pixel electrode 20, and the cavity 301 connected to the pixel electrode 20 displays black, that is, the e-paper device 1 executes the drawing function.

When the power management unit 110 provides a positive voltage to the conductive layer 10 and provides a negative voltage to the common electrode layer 40, as described above, once the e-paper device 1 is touched, the pixel electrode 20 corresponding to the touch position contacts the conductive layer 10 and at positive voltage. Then the charged particles 303 are driven to move away from the pixel electrode 20, and the cavity 301 connected to the pixel electrode 20 displays white, namely the drawing on the touch position is erased.

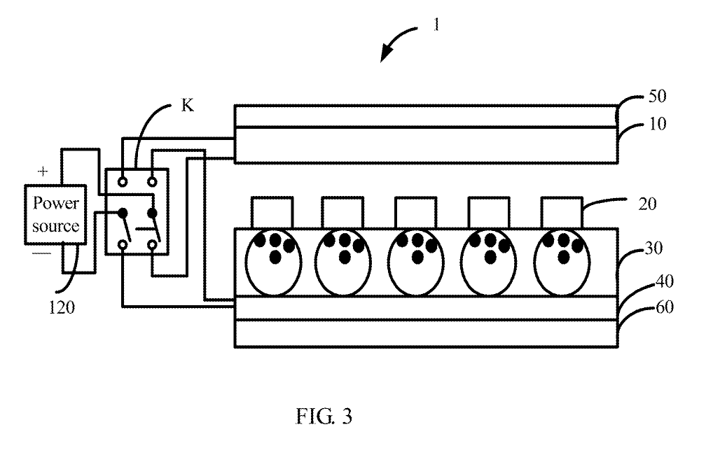

FIG. 3 is a schematic view of a substructure of the electrophoretic display device 1 capable of executing an eraser function in accordance with another embodiment. As compared to FIG. 2, the e-paper device 1 of FIG. 3 further includes a double pole double throw (DPDT) switch K but do not includes the power management unit 110. The conductive layer 10 and the common electrode layer 40 are electrically connected to the anode and the cathode of the power source 120 via the DPDT switch K. The conductive layer 10 and the common electrode layer 10 can be respectively connected to the anode, the cathode of the power source 120, or can be respectively connected to the cathode, the anode of the power source 10 by switching the DPDT switch K. Therefore, the voltage of the conductive layer 10 and the common electrode layer 40 can be exchanged, causing the e-paper device 1 to enter the erase mode or exists the erase mode accordingly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic paper (e-paper) device comprising:
a conductive layer corresponding to a display surface of the e-paper device;
a plurality of pixel electrodes arranged in matrix pattern, each pixel electrode corresponding to a coordinate of a coordinate system;
a common electrode layer;
an electrophoretic ink layer, electrically connected between the plurality of pixel electrodes and the common electrode layer;
a voltage detection unit, connected to the plurality of pixel electrodes, and configured to detect voltages of the pixel electrodes; and
a processing unit;
wherein, the conductive layer has a first voltage and the common electrode layer has a second voltage different from the first voltage when the e-paper device is powered on, the plurality of pixel electrodes are located between the conductive layer and the electrophoretic ink layer, when the e-paper device is touched by a user, the pixel electrode corresponding to the touch position contacts the conductive layer and obtains the first voltage, which causes a color change of the position of the electrophoretic ink layer corresponding to the touch position; the voltage detection unit detects the first voltage of the pixel electrode and produces a touch signal, and the processing unit determines the touch position according to the touch signal.

2. The e-paper device according to claim 1, wherein the electrophoretic ink layer comprises a plurality of cavities, each cavity is arranged between one of the plurality of pixel electrodes and the common electrode layer, and comprises suspension fluid, and at least one type of charged particles dispersed in the suspension fluid; when a pixel electrode obtains the first voltage, the charged particles of the cavity connected to the pixel electrode are driven move toward to or move away from the pixel electrode with the first voltage, causing the color change of the cavity.

3. The e-paper device according to claim 1, further comprising a spacer layer between the conductive layer and the plurality of pixel electrodes, the spacer layer is configured for spacing the conductive layer and the plurality of pixel electrodes apart when the e-paper device is not be depressed by the user.

4. The e-paper device according to claim 1, further comprising a thin-film transistor (TFT) matrix circuit and a drive control circuit, wherein the TFT matrix circuit comprises a plurality of TFTs, each TFT is connected to one pixel electrode, the drive control circuit is connected between the TFT matrix circuit and the processing unit and is configured to turn on corresponding TFTs and applies corresponding driving voltage to the pixel electrodes connected to the TFTs which are turned on, when receiving a display signal from the processing unit; then the charged particles of the cavities connected to the pixel electrodes applied voltage are driven move toward to the pixel electrode or move away from the pixel electrode, the e-paper device displays an image corresponding to the display signal.

5. The e-paper device according to claim 4, wherein the processing unit is further configured to transmit a clearing signal to the drive control circuit when the e-paper device enters a clear mode, the drive control circuit turns on all of the TFTs and applies corresponding driving voltage to all of the pixel electrodes to cause all of the cavities display white color, when receiving the clearing signal.

6. The e-paper device according to claim 4, wherein when the e-paper device enters an erase mode and the e-paper device is touched, the processing unit determines the touch position and controls the drive control circuit to apply a corresponding voltage to the pixel electrode located on the touch position to cause the cavity connected to the pixel electrode to display white.

7. The e-paper device according to claim 6, further comprising a power management unit and a power source, wherein the power management unit is connected to the conductive layer and the common electrode layer, the processing unit controls the power management unit to provide different voltage to the conductive layer and the common electrode layer, when the voltage provided to the conductive layer and the common electrode layer are exchanged, the e-paper device enters or exists the erase mode correspondingly.

8. The e-paper device according to claim 6, further comprising a double pole double throw (DPDT) switch and a power source, wherein the conductive layer and the common electrode layer are electrically connected to an anode and a cathode of the power source by the DPDT switch, the e-paper device can enter the erase mode or exist the erase mode by switching the DPDT switch.

9. The e-paper device according to claim 2, wherein the cavities are one selected from the group consisting of microcapsules and micro-cups.

10. An electronic paper (e-paper) device comprising:
a conductive layer corresponding to a display surface of the e-paper device;
a plurality of pixel electrodes arranged in matrix pattern, each pixel electrode corresponding to a coordinate of a coordinate system;
a common electrode layer;
an electrophoretic ink layer comprising a plurality of cavities, each cavity being arranged between one of the plurality of pixel electrodes and the common electrode layer, and comprising suspension fluid, and charged particles dispersed in the suspension fluid;
a thin-film transistor (TFT) matrix circuit comprising a plurality of TFTs, each TFT being connected to one pixel electrode;
a processing unit, and
a drive control circuit, connected to the TFT matrix circuit and the processing unit, configured to receive a display signal from the processing unit and turn on corresponding TFTs and apply corresponding driving voltages to the pixel electrode connected to the TFTs which are turned on according to the display signal, then the charged particles of the cavities connected to the pixel electrode which are applied voltage are driven move toward to the pixel electrode or move away from the pixel electrode, and the e-paper device displays an image corresponding to the display signal accordingly;
wherein, the conductive layer has a first voltage and the common electrode layer has a second voltage different from the first voltage when the e-paper device is powered on, the plurality of pixel electrodes are located between the conductive layer and the electrophoretic ink layer, when the e-paper device is touched by a user, the pixel electrode corresponding to the touch position contacts the conductive layer and obtains the first voltage, which causes a color change of the position of the electrophoretic ink layer corresponding to the touch position.

11. The e-paper device according to claim 10, further comprising a spacer layer between the conductive layer and the plurality of pixel electrodes, the spacer layer is configured for spacing the conductive layer and the plurality of pixel electrodes apart when the e-paper device is not be depressed by the user.

12. The e-paper device according to claim 10, wherein the processing unit is further configured to transmit a clearing signal to the drive control circuit when the e-paper device enters a clear mode, the drive control circuit turns on all of the TFTs and applies corresponding driving voltage to all of the pixel electrodes to cause all of the cavities display white, when receiving the clearing signal.

13. The e-paper device according to claim 10, wherein when the e-paper device enters an erase mode and the e-paper device is touched, the processing unit determines the coordinates of the touch position and controls the drive control circuit to apply a corresponding voltage to the pixel electrode located on the touch position to cause the cavity connected to the pixel electrode to display white.

14. The e-paper device according to claim 10, further comprising a power management unit and a power source, wherein the power management unit is connected to the conductive layer and the common electrode layer, the processing unit controls the power management unit to provide different voltage to the conductive layer and the common electrode layer, when the voltage provided to the conductive layer and the common electrode layer are exchanged, the e-paper device enters or exist the erase mode correspondingly.

15. The e-paper device according to claim 10, further comprising a double pole double throw (DPDT) switch and a power source, wherein the conductive layer and the common electrode layer are electrically connected to an anode and a cathode of the power source by the DPDT switch, the e-paper device can enter the erase mode or exist the erase mode by switching the DPDT switch.

16. The e-paper device according to claim 10, wherein the cavities are one selected from the group consisting of microcapsules and micro-cups.
